(19) United States
(12) Patent Application Publication
(10) Pub. No.: US 2004/0090958 A1
(43) Pub. Date: May 13, 2004

(54) Method for transmitting and receiving packets to support internet handover service in wired and wireless combined network

(76) Inventors: Chang-Min Park, Daejeon-city (KR); Tae-Il Kim, Daejeon-city (KR); Young-Sun Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/455,590

(22) Filed: Jun. 5, 2003

(30) Foreign Application Priority Data
Nov. 13, 2002 (KR) 2002-70393

(51) Int. Cl. H04L 12/28

(52) U.S. Cl. 370/389

(57) ABSTRACT

The present invention relates to a method for internet protocol addressing and packet processing for an internet handover service in a wired and wireless combined network. More specifically, the present invention relates to a method for transmitting and receiving packets in a wired and wireless combined network so as to enable IP addressing and packet transmission when a user accesses a public internet network through a private internet provider. Moreover, the method according to the present invention may satisfy requirements to be supported under a mobile communication environment such as fixed IP assignment for internet connection, handover, and tunneling etc., by MLIP address.

### CROSS REFERENCE TO RELATED APPLICATION

This application is based on Korea Patent Application No. 10-2002-0070393 filed on Nov. 13, 2002, in the Korean Intellectual Property Office, the content of which is incorporated herein by reference.

### BACKGROUND OF THE INVENTION

(a) Field of the Invention

The present invention relates to a method for internet protocol (hereinafter referred to as “IP”) addressing and packet processing for an internet handover service in a wired and wireless combined network. More specifically, the present invention relates to a method for transmitting and receiving packets in a wired and wireless combined network so as to enable IP addressing and packet transmission when a user accesses a public internet network through a private internet provider.

(b) Description of the Related Art

In a wired and wireless combined network for providing an internet service, an internet protocol address system referred to as “lPv4 (Internet Protocol Version 4)” has been used. However, the IPv4 address system is limited in that it cannot accept a continuously-increasing number of service terminals due to lack of IP address capacity.

To solve such problem of address capacity, it is considered that a private internet address system of IPv4 and an IPv6 address system may be adapted to a wired and wireless internet network. However, the two address systems also have their own problems.

More specifically, when the private internet address system of IPv4 is adapted, there exists a problem in that it is difficult for the IPv4 to support a terminal-to-terminal bidirectional internet service defined by NAT (Network Address Translation). Moreover, when the IPv6 address system is adapted, there exists a problem in that the time to realize a network for supporting the IPv6 address system is indefinite and network exchange between networks for supporting IPv4 and IPv6 respectively is difficult.

In connection with IP addressing for an internet service, “A method for providing internet service between end terminal devices through dial-up connection to a PSTN (Public Switched Telephone Network)” has been published as Japanese Patent Publication No. 1998-149325.

The above prior art provides a simple and interactive communicating function between end terminal devices connecting to the internet by dialing up the PSTN.

According to the prior art, a server function program manages internet protocol addresses on the internet. Each of the end terminal devices starts the interactive communication system and receives an internet protocol address through the server function program. Then, each of the end terminal devices transmits the internet protocol address to corresponding terminal devices. A client function program connects with each of the end terminal devices directly.

Although the prior art provides an interactive internet service between end terminal devices by using a PSTN, it does not disclose any detailed solution to solve the lack of IP address capacity.

In connection with effective usage of IP address, “A method for establishing communication on the internet with a client having a dynamically assigned IP address” has been patented in the United States under the U.S. Pat. No. 6,026,441. The prior art according to the above U.S. patent provides internet service between a source terminal and a destination terminal, and it informs the source terminal of a dynamically assigned IP address of a destination terminal.

The prior art according to the above U.S. patent has a problem in that it requires an IASP (Internet Access Service Provider) for a dynamic IP establishment and communication procedure between the source terminal and the IASP so as to efficiently utilize a dynamic IP address. Moreover, there is a problem in the prior art in that the source terminal should previously obtain various kinds of IP addresses of the destination terminal so as to establish an internet connection with the destination terminal having IP addresses dynamically assigned by an IASP.

### SUMMARY OF THE INVENTION

The technical solution of the present invention is to provide a method of transmitting and receiving packets for an internet handover service in a wired and wireless combined network

In one aspect of the present invention, there is provided a method of transmitting and receiving packets for an internet handover service in a wired and wireless combined network, wherein the internet handover service is implemented under a communication environment having a plurality of wireless private networks that use a public network as a backbone, a wireless terminal connected to any one of the wireless private networks, a plurality of wired private networks, and a wired terminal connected to any one of the wired private networks. The method comprises the steps of:

(a) the wireless terminal receiving an allocated private IP address from any one of the wireless private networks;

(b) the wired terminal receiving an allocated private IP address from any one of the wired private networks; and

(c) the wireless terminal and the wired terminal each forming an option field of a multi layer IP packet by using the wireless and the wired private IP addresses and a public IP address which is allocated from the public network to each of the wireless and wired private networks, and transmitting and receiving the multi layer IP packet for communication.

Preferably, the multi layer IP packet comprises an option field. More specifically, the option field includes address information for defining the private IP addresses of a transmission part and a reception part; length information of the option field; terminal type information, private IP address, and identification information of the transmission part; and terminal type information, private IP address, and identification information of the reception part.

When the wireless terminal is moved from any one of the wireless private networks to another one of the wireless private networks, it is preferable that the method further comprises the steps of:

the wireless terminal requesting another private IP address from another wireless private network and receiving another allocated private IP address in response to the request;

the wireless terminal requesting mobile IP registration from a foreign agent belonging to the other wireless private network, and performing a tunneling operation between a home agent belonging to one wireless private terminal and a foreign agent belonging to another wireless private network; and

the wireless terminal and the wired terminal each forming a multi layer IP packet by using a wireless private IP address, another wireless private IP address, a wired private IP address, and a public IP address which is allocated from the public network to each of the wireless private networks and the wired private networks, and transmitting and receiving the multi layer IP packet for communication.

In another aspect of the present invention, there is provided a method for processing transmission of a multi layer IP packet through an internet service between a wireless terminal belonging to a wireless private network that uses a public network as a backbone and a wired terminal belonging to a wired private network. The method comprises the steps of:

(a) a transmission part adding header information into a TCP/UDP payload for data transmission and confirming a public IP address of the public network and a private IP address of the private network, each network belonging to the transmission part, and confirming a public IP address of the public network and a private IP address of the private network, each network belonging to a reception part;

(b) the transmission part recording a source public IP address and a destination public IP address confirmed in (a) into a source address field and a destination address field of an IP packet to be respectively transmitted, and recording the source private IP address and the destination private IP address confirmed in (a) into an option field of the IP packet;

(c) calculating a checksum of a TCP/UDP header by using the source public IP address and the destination public IP address, and recording the checksum into a checksum field; and

(d) comparing the source public IP address with the destination public IP address, interchanging the destination public IP address with the destination private IP address when the two public addresses are the same, calculating and recording the checksum of the total IP packet, and transmitting the IP packet into the reception part.

Preferably, the step (d) further comprises:

(e) determining whether the source private IP address exists in the IP packet when the two public IP addresses are not the same in (d); and

(f) the transmission part interchanging the source public IP address with the source private IP address when the source private IP address exists in (e), calculating a checksum of the IP packet, and transmitting the IP packet into the reception part.

In still another aspect of the present invention, there is provided a method for processing reception of a multi layer IP packet through an internet service between a wireless terminal belonging to a wireless private network that uses a public network as a backbone and a wired terminal belonging to a wired private network. The method comprises following steps of:

(a) the reception part receiving an IP packet, calculating a checksum of the IP packet, and determining whether a checksum error exists;

(b) the reception part determining whether a public IP address of itself is the same as a reception public IP address when a checksum error does not exist in (a), and confirming whether a destination private IP address exists in the IP packet when the two IP addresses are the same;

(c) the reception part interchanging a destination public IP address with a destination private IP address when it is determined that the destination private IP address exists in the IP packet in (b), confirming whether the interchanged destination public IP address is the same as the public IP address of itself, and determining whether a source private IP address exists in the IP packet when the two public IP addresses are the same; and

(d) interchanging a source public IP address with the source private IP address when it is determined in (c) that the source private IP address exists in the IP packet, and performing packet processing in accordance with properties of the IP packet.

Preferably, the method further comprises a step for renouncing the IP packet when a checksum error exists in (a).

Moreover, it is preferable that the step (b) of the method further comprises a step for determining whether the source public IP address is a handover IP address when the public IP address of the reception part is the same as the destination public IP address, and performing IP packet tunneling and IP packet forwarding when the source public IP address is a handover IP address.

Moreover, it is preferable that the step (c) further comprises following steps of:

the reception part determining whether the source private IP address exists in the IP packet when the interchanged destination private IP address is not the same as the public IP address of the reception part;

the reception part confirming whether the source public IP address of the IP packet is the same as the source private IP address when the source private IP address exists, and interchanging the source public IP address with the source private IP address when the source public IP address of the IP packet is the same as the source private IP address; and

the reception part performing IP packet tunneling and IP packet forwarding when the interchanged source public IP address is a handover IP address.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 illustrates a block diagram of a wired and wireless combined internet service system in accordance with an embodiment of the present invention.

FIG. 2 illustrates public IP addresses used in an RFC 791 internet protocol.

FIG. 3 illustrates private IP addresses used in the RFC 791 internet protocol.

FIG. 4 illustrates a message format of an IPv4 protocol.

FIG. 5 illustrates a format of the option field in FIG. 4 for address expansion of the IPv4 protocol.

FIG. 6 illustrates configuration of packet header information in multilayer internet protocol using the IP packet header in FIG. 4 and the option field information in FIG. 5.

FIG. 7 illustrates a block diagram for describing a packet procedure of an IP layer in a wired terminal and a wireless terminal in accordance with an embodiment of the present invention.

FIG. 8 illustrates a processing procedure of a mobile internet service in a wired and wireless combined network in accordance with an embodiment of the present invention.

FIG. 9 illustrates a handover procedure of the mobile internet service in a wired and wireless combined network in accordance with an embodiment of the present invention.

FIG. 10 illustrates a transmission processing procedure by using IP addresses of a multilayer internet protocol (MLIP) packet in a wired and wireless mobile terminal in accordance with an embodiment of the present invention.

FIG. 11 illustrates a reception processing procedure by using IP addresses of a MLIP packet in a wired and wireless mobile terminal in accordance with an embodiment of the present invention.

FIG. 12 illustrates service compatibility in a case when IP addresses are used in a wired and wireless mobile in accordance with an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

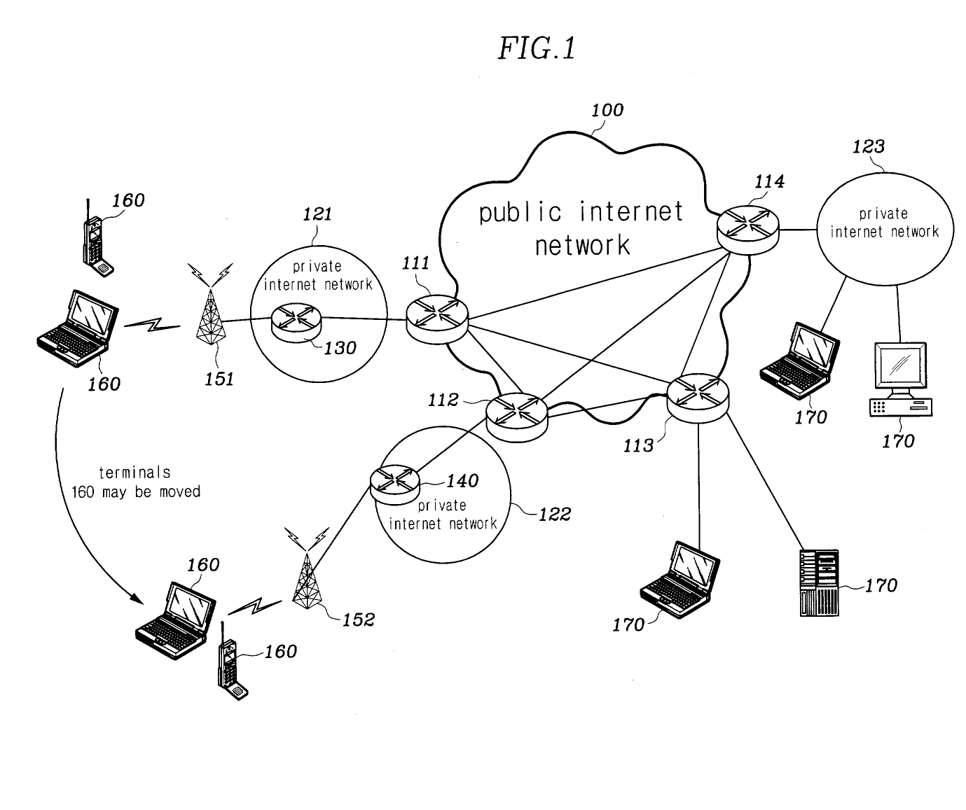

Referring to FIG. 1, a wired and wireless combined internet service system comprises a public internet network 100, a plurality of routers 111 to 114, a pair of wireless private internet networks 121 and 122, a home agent (HA) 130, a foreign agent 140, a pair of base stations 151 and 152, various kinds of wireless terminals 160, a wired private internet network 123, and various kinds of wired terminals 170.

The public internet network 100 is comprised of a backbone combined with a wired and wireless network. Therefore, an IPv4 address system is required to use the internet service.

As shown in FIG. 1, the private internet networks 121 and 122 are based on a wireless network while the private internet network 123 is based on a wired network. The home agent 130 is located at the private internet network 121 and records location information on the wireless terminals 160. The foreign agent 140 is located at the private internet network 122 and serves as a router for data transmission to the wireless terminals 160 together with the home agent 130.

Each of the private internet networks 121 and 122 is connected to the wireless terminals 160 via the corresponding base stations 151 and 152. A user may access an internet service through the wireless terminals 160.

Since the wired terminals 170 are directly connected to the private internet network 123, a user can access internet service through the wired terminals 170. Alternatively, it is possible to access the internet service by directly connecting the wired terminals 170 to the public internet network 100.

Since the private internet network 123 has a function of NAT (network address translation), it assigns private IP addresses to the wired terminals 170 and enables the wired terminals 170 to access the internet service by using predetermined public IP addresses.

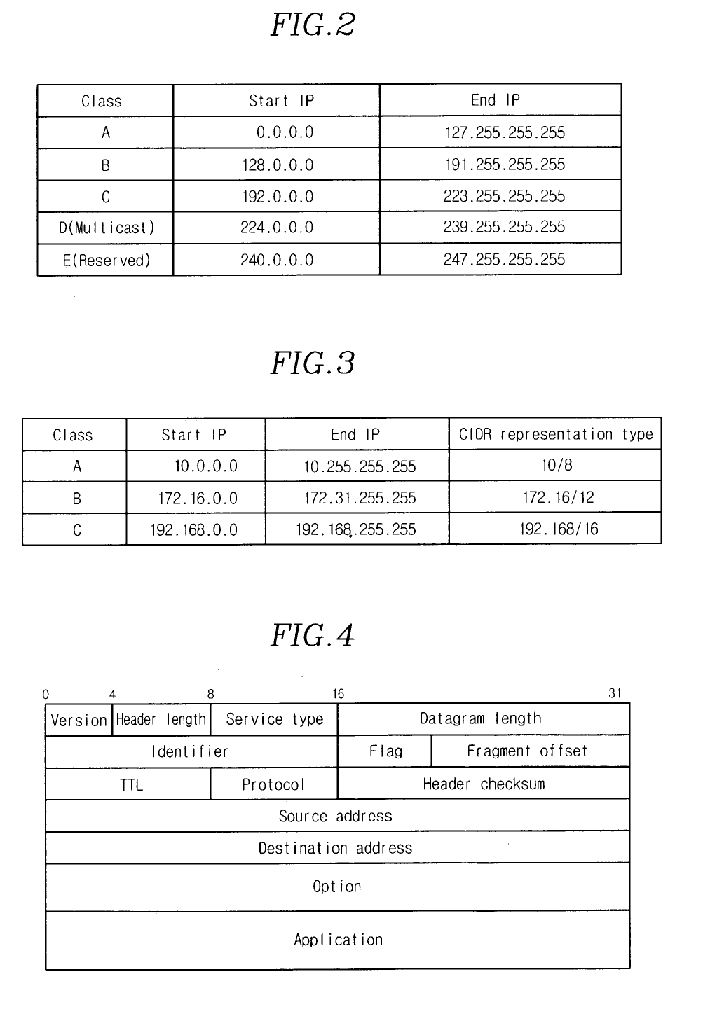

In FIG. 2, public IP addresses used in a RFC 791 internet protocol are illustrated.

With reference to FIG. 2, the public IP addresses have a layer structure and include five kinds of classes. The public IP addresses are classified into two kinds of categories, such as start IP address and end IP address. From a hierarchical point of view, the public IP addresses may be classified as A class, B class, and C class. D class is provided for multicasting, and E class is provided for future use.

Private IP addresses are assigned to the wireless terminals 160 or the wired terminals 170 through the function of NAT, which is used in the private internet network. The private IP addresses are defined and used in the following.

In FIG. 3, private IP addresses used in the RFC 791 internet protocol are illustrated.

The private IP addresses are used for solving a lack of address capacity of the public IP addresses. With reference to FIG. 3, the private IP addresses are classified as three kinds of classes such as A class, B class, and C class, and are assigned to the terminals connected to the private internet network. Each of the classes has a start IP address, an end IP address, and CIDR (Classless Inter Domain Routing) masking values. The private IP addresses may not be used in the public internet network.

In the wired and wireless combined internet service system having the above-described configuration, a wireless terminal 160 is activated to access a desired bidirectional internet service. At this time, when the wireless terminal 160 is moved from the private internet network 121 to the private internet network 122 while supporting bidirectional access between the public internet network 100 and the wireless terminal 160, a handover operation should be supported.

To support the handover operation as described above, the packet format that is interchanged between the wireless terminal 160 and the public internet network 100 has been newly defined in this embodiment.

In FIG. 4, a message format of an IPv4 protocol is illustrated.

With reference to FIG. 4, the IPv4 protocol message has a header field, and the header field includes information on version, header length, service type, datagram length, identifier, flags, fragment offset, TTL (time to live), protocol, and header checksum. Moreover, the IPv4 protocol message further includes a source address field, a destination address field, an option field, and an application field.

Since the header length information has four bytes, the equation “4×15=60” reveals that the maximum length of the header field is sixty bytes. Moreover, the source address and the destination address have four bytes each, and they may be assigned as defined in FIG. 2 and FIG. 3. The option field may be assigned up to the maximum of forty bytes in addition to the twenty default bytes.

In accordance with the embodiment of the present invention, an option field may be defined and used for multi layer internet protocol (MLIP) addresses while maintaining the conventional packet format of the IPv4 protocol.

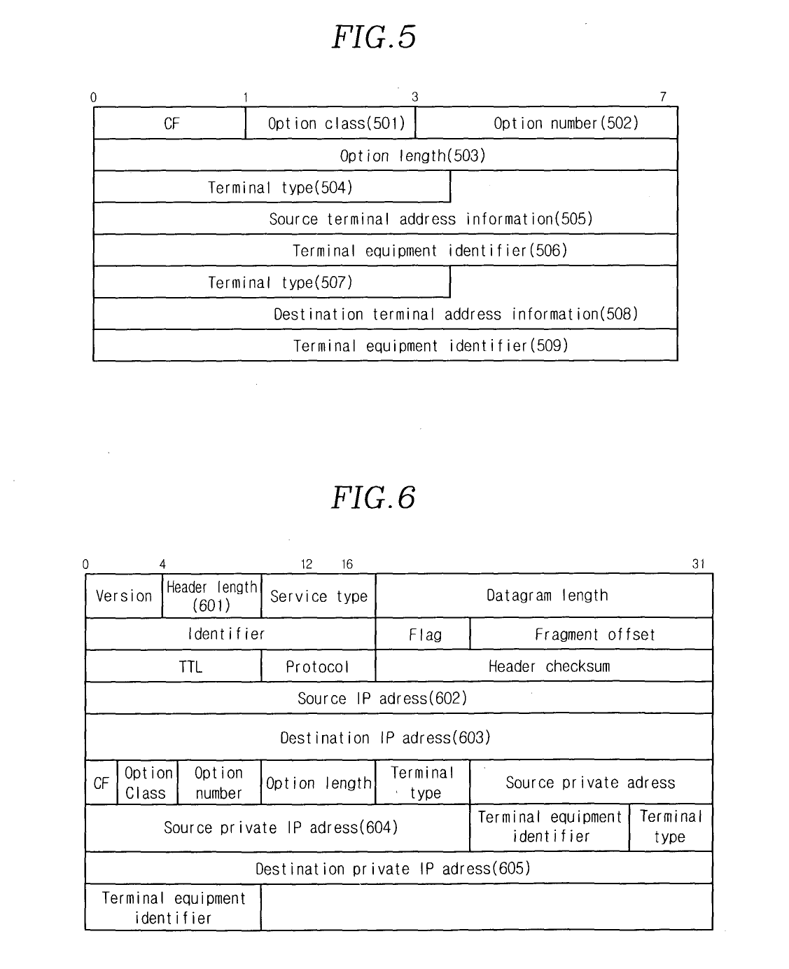

In FIG. 5, the format of the option field in FIG. 4 for address expansion of the IPv4 protocol is illustrated.

With reference to FIG. 5, a first octet of the option field is a control field, and the first octet includes an option class 501 and an option number 502. A second octet of the option field includes an option length 503.

Types of terminals, such as a conventional terminal, a mobile terminal, a VolP (Voice Over Internet Protocol) service terminal, or informational home applied equipment are recorded in the data field of terminal type 504. Private IP addresses are recorded in the data field of source terminal address information 505.

Since a plurality of terminals having the same private IP addresses as home network devices may be accessed, information for identifying these devices is recorded in a data field of terminal equipment identifier 506. Moreover, data fields of destination terminal type 507, destination terminal address information 508, and destination terminal equipment identifier 509 are provided.

An IPv4 message format is formed comprising the above described option fields.

In FIG. 6, configuration of packet header information in multilayer internet protocol using the IP packet header in FIG. 4 and the option field information in FIG. 5 is illustrated.

With reference to FIG. 6, a data field 601 for recording header length information of a packet and a data field 602 for recording a source public IP address are provided. Moreover, a data field 603 for recording a destination public IP address is provided. A data field 604 for recording a source private IP address and a data field 605 for recording a destination private IP address are also respectively provided. The above IP addresses experience conversion of field information by a MLIP (Multi Layer Internet Protocol) procedure.

A method for transmitting and receiving the above IP packets will be described in the following.

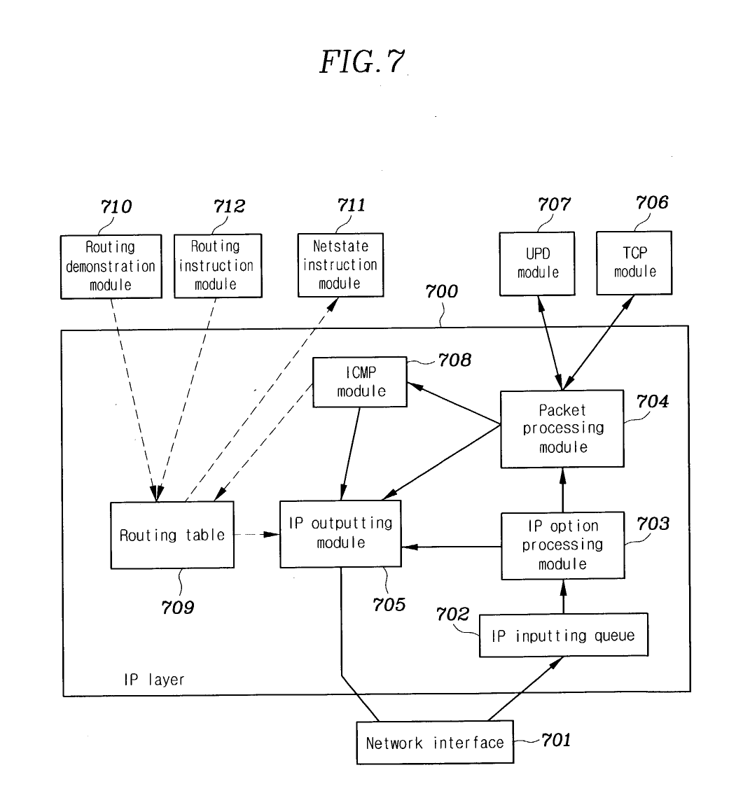

In FIG. 7, a block diagram for describing a packet procedure of an IP layer in a wired terminal and a wireless terminal in accordance with an embodiment of the present invention is illustrated.

With reference to FIG. 7, each router 111 to 114 for processing packets in an IP layer comprises a network interface 701, an IP inputting queue 702, an IP option processing module 703, a packet processing module 704, an IP outputting module 705, a TCP (Transmission Control Protocol) module 706, an UDP (User Datagram Protocol) module 707, an ICMP (Internet Control Message Protocol) module 708, a routing table 709, a routing demonstration module 710, a Netstat instruction module 711, and a routing instruction module 712.

The above routers 111 to 114 for processing packets in an IP layer have similar configurations for basic functions as prior routers, and they merely further comprise an IP option processing module 703 for processing additionally added option information.

The routing table 709 receives control information from the routing demonstration module 710, the routing instruction module 712, the Netstat instruction module 711, and the ICMP module 708, and amends routing information on the basis of the received control information.

Packet data are received at the interface network 701 which is a kind of link layer, and the packet data are transmitted from the interface network 701 to the IP inputting queue 702. The IP inputting queue 702 performs a source routing process in accordance with a conventional IP option procedure. When the received packet data have an additionally added option field as described in FIG. 6, the IP option processing module 703 processes the packet received at the IP inputting queue 702. Moreover, when the received packet data have no additionally added option field, the packet processing module 704 transmits the received packet data into the TCP module 706, the UDP module 707, or the ICMP module in accordance with the type of packet data, and the received packet data are processed in the above corresponding module.

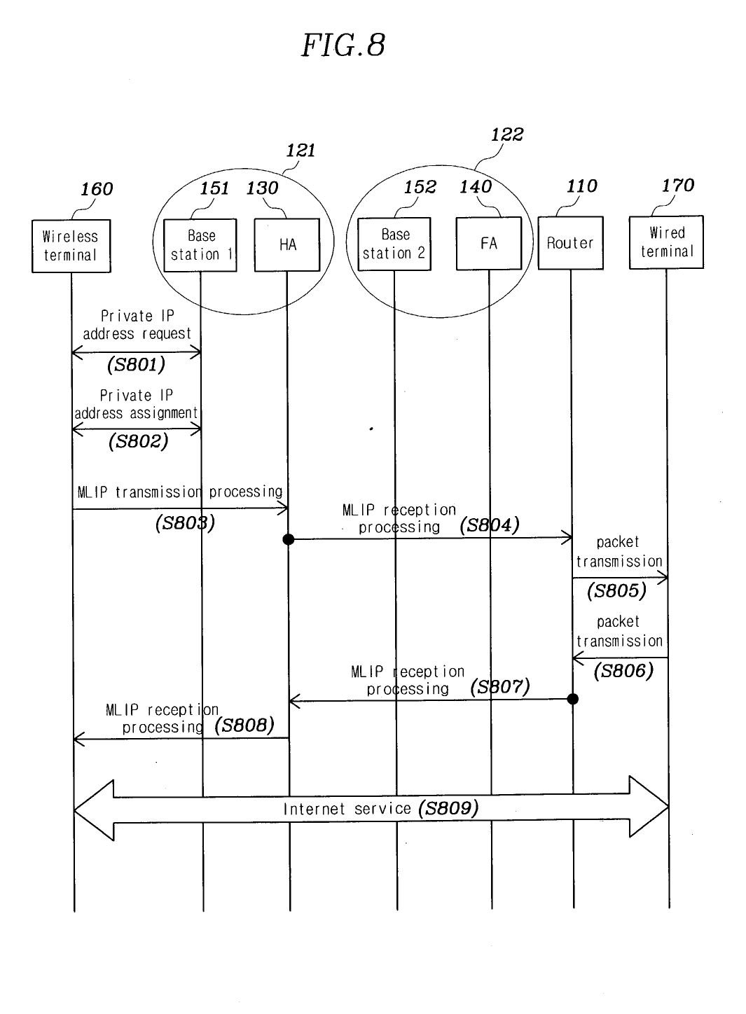

In FIG. 8, the processing procedure of a mobile internet service in a wired and wireless combined network in accordance with an embodiment of the present invention is illustrated.

With reference to FIG. 8, a private internet network 121 including a first base station 151 and a home agent 130, a private internet network 122 including a second base station 152 and a foreign agent 140, and a router 110 are provided between a wireless terminal 160 and a wired terminal 170 so as to perform data communication.

When the wireless terminal 160 desires to transmit packet data to the wired terminal 170 or receive packet data from the wired terminal 170, the wireless terminal 160 requests private IP addresses from the first base station 151 of the private internet network 121 to which the wireless terminal 160 belongs (step 801). Then, the wireless terminal 160 receives allocated private IP addresses in response to the request (step 802).

At this time, the allocation of private IP addresses is dynamically performed at a mobile internet environment by a router agent. This allocation of private IP addresses is the same as a conventional IPv4 addressing system or a mobile IPv4 addressing system. In the present embodiment, two addresses such as ip1 and pip1 are allocated. The ip1 is a representative IP address of the router to be accessed and the pip1 is a private IP address of the terminal.

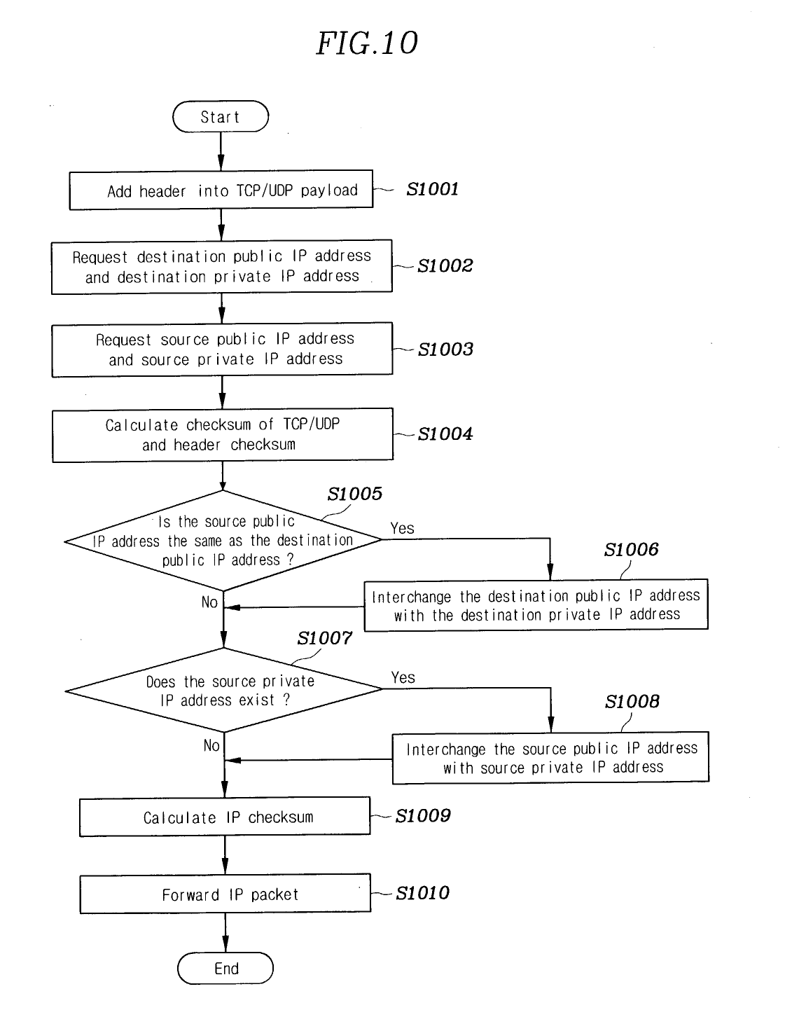

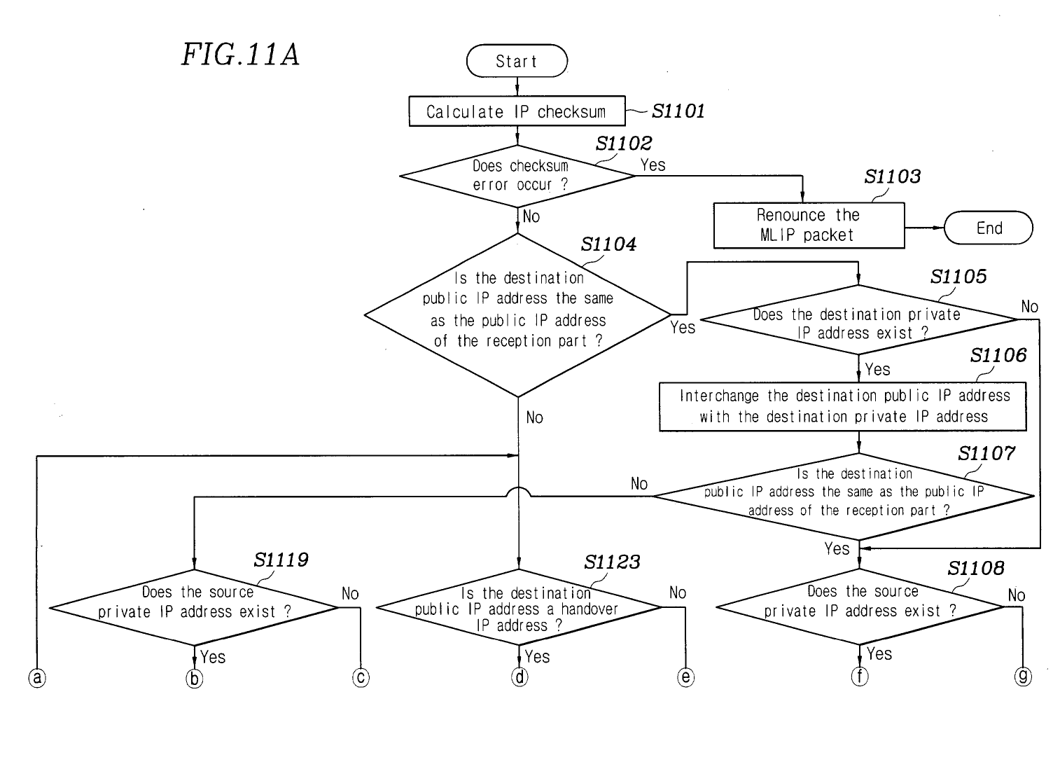

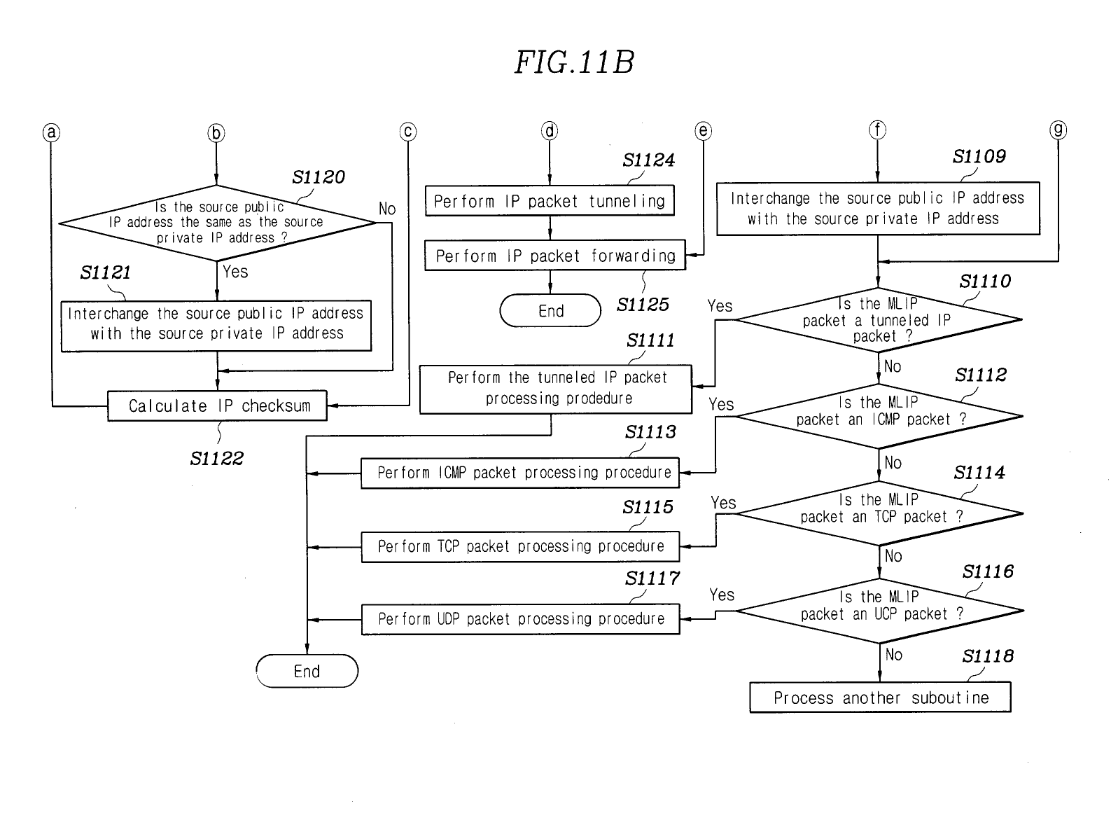

The wireless terminal that has received allocated private IP addresses transmits packet data to the home agent 130 through an MLIP transmission processing procedure (step 803), and the home agent 130 transmits the packet data to the router 110 through an MLIP reception processing procedure (step 804). The MLIP transmission and reception processing procedures will be specifically described later with reference to FIGS. 10 and 11.

The router 110 transmits packet data to the wired terminal 170 in accordance with destination information of the IP addresses in the packet data transmitted from the wireless terminal 160 (step 805). At this time, the processing procedure is based on the configuration described in FIG. 7.

When packet data are transmitted from the wired terminal 170 to the wireless terminal 160, the wired terminal 170 transmits packet data to the router 110 through a packet transmission method in the opposite order to what is described above (step 806). The router 110 transmits the packet data to the home agent 130 through the MLIP reception processing procedure (step 807).

Then, the home agent 130 transmits the packet data to the wireless terminal 160 through the MLIP reception processing procedure (step 808).

As described above, the wireless terminal 160 and the wired terminal 170 may transmit packet data to each other through the internet service.

When the wireless terminal 160 is moved from a region of the private internet network 121 to a region of the private internet network 122 while utilizing the above-described internet service, the internet service may be supplied to the wireless terminal 160 without disconnection through a handover operation.

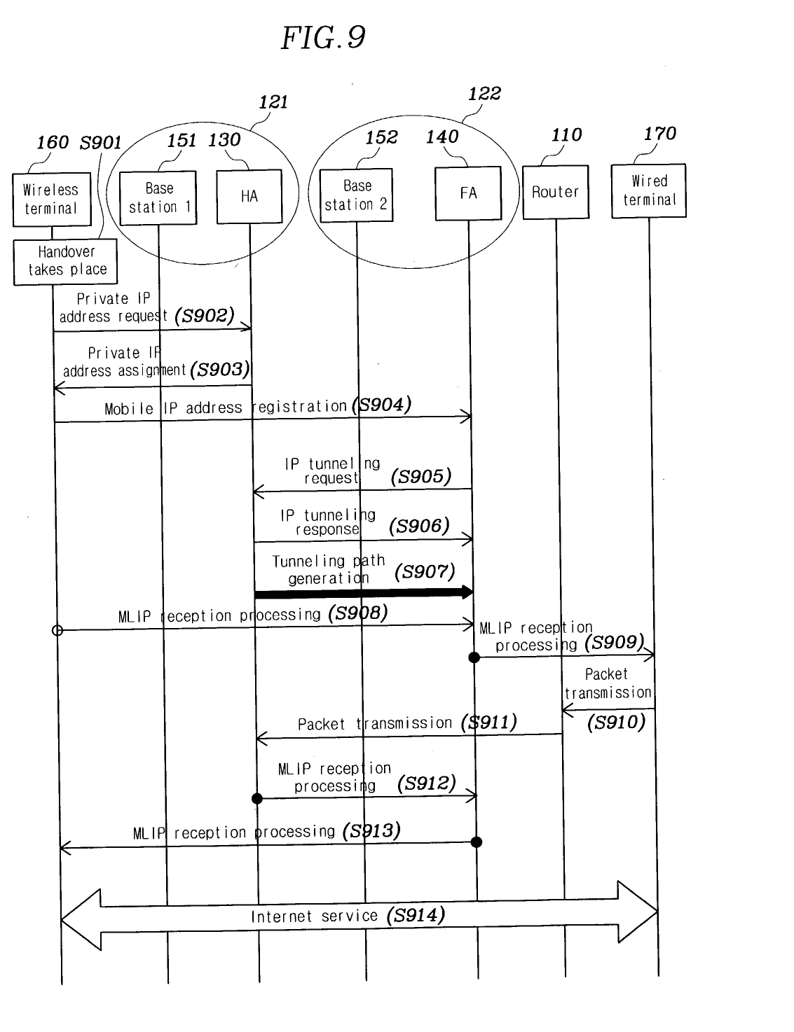

In FIG. 9, the handover procedure of the mobile internet service in a wired and wireless combined network in accordance with an embodiment of the present invention is illustrated.

With reference to FIG. 9, when the wireless terminal 160 is moved to a region of another private internet network while utilizing internet service, a handover phenomenon takes place (step 901). Then, the wireless terminal 160 requests allocation of private IP addresses to the second base station 152 of the private internet network where the wireless terminal 160 has been moved (step 902). The wireless terminal receives allocated private IP addresses by receiving a response signal from the second base station 152 (step 903).

The wireless terminal 160 requests mobile IP address registration from the foreign agent 140 in accordance with a mobile IP protocol procedure (step 904). The foreign agent 140 transmits a tunneling COA (care of address) for IP tunneling to the home agent 130 of the private internet network 121 (step 905).

The home agent 130 registers the tunneling address by using the COA received from the foreign agent 140 and responses to the IP tunneling request (step 906). Then, the foreign agent 140 registers the tunneling address and thus the tunneling path is generated (step 907).

The wireless terminal 160 may transmit packet data to the foreign agent 140 in accordance with an MLIP transmission processing procedure (step 908). The foreign agent 140 transmits the received packet data to the wired terminal 170 in accordance with MLIP reception processing procedure (step 909).

Next, transmission of packet data from the wired terminal 170 to the wireless terminal 160 will be described. The wired terminal 170 transmits packet data to the router 110 in accordance with a packet transmission procedure (step 910). Then, the router 110 transmits the received packet data to the home agent 130 in accordance with the packet transmission procedure (step 911).

The home agent 130 performs tunneling to the packet data received from the router 110 in accordance with an MLIP reception processing procedure and transmits the packet data to the foreign agent 140 (step 912). Then, the foreign agent 140 transmits the tunneled packet data to the wireless terminal 160 in accordance with the MLIP reception processing procedure (step 913).

Even though a handover phenomenon occurs, data transmission and reception between the wired terminal 170 and the wireless terminal may be performed through the internet service provided by the mobile IP function as described above (step 914).

Next, the MLIP transmission processing procedure in FIGS. 8 and 9 will be described specifically.

In FIG. 10, a transmission processing procedure using IP addresses of a multilayer internet protocol (MLIP) packet in a wired and wireless mobile terminal in accordance with an embodiment of the present invention is illustrated.

With reference to FIG. 10, when transmission processing procedure starts, a transmission part for transmitting MLIP packet data adds a header into a TCP/UDP payload that is included in the packet data (step 1001).

Then, the transmission part requests a destination public IP address and a destination private IP address for internet service from a DNS (Domain Name Server) (step 1002). The requested IP addresses are inputted to an option field of the packet data. At this time, when the transmission part possesses the destination IP addresses, it may be possible to input the destination public IP address and the destination private IP address to the option field directly instead of requesting those IP addresses from the DNS.

Next, the transmission part fetches public and private IP addresses of itself from the DNS (step 1003). These IP addresses are called “source IP addresses”. The source public IP address and the destination public IP address are respectively recorded into the source address field and the destination address field of the packet data. Moreover, the private IP addresses are recorded into the option field of the IP header.

Then, the transmission part calculates a checksum of the TCP/UDP and the header by using the fetched source public IP address and destination public IP address, and records the calculated checksum into the checksum region of the packet (step 1004).

The transmission part determines whether the source public IP address is the same as the destination public IP address (step 1005). When the source public IP address is the same as the destination public IP address in the step 1005, it is considered that packet transmission is desired between the transmission part and the reception part belonging to the same private internet network. Thus, the transmission part interchanges the destination public IP address with the destination private IP address and records them into their respective fields (step 1006).

When the source public IP address is not the same as the destination public IP address in the step 1005, the transmission part confirms whether the source private IP address exists (step 1007). In the case that the source private IP address exists in the step 1007, the transmission part interchanges the source public IP address with the source private IP address (step 1008).

When it is determined in the step 1007 that the source private IP address does not exist, the transmission part calculates the IP checksum (step 1009) and then forwards the IP packet (step 1010).

In the following, the MLIP reception processing procedure will be described.

In FIG. 11, the reception processing procedure by using IP addresses of a MLIP packet in a wired and wireless mobile terminal in accordance with an embodiment of the present invention is illustrated.

With reference to FIG. 11, when the reception processing procedure starts, a reception part receives an MLIP packet and calculates a checksum of the MLIP packet (step 1101). Then, the reception part confirms whether a checksum error has occurred (step 1102). At this time, when it is determined in the step 1102 that a checksum error has occurred in the MLIP packet, the reception part renounces the MLIP packet (step 1103).

When it is determined in the step 1102 that a checksum error has not occurred in the MLIP packet, the reception part confirms whether the destination public IP address of the received MLIP packet is the same as the public IP address of the reception part (step 1104). Then, when it is determined in the step 1104 that the public IP address of the received MLIP packet is the same as the public IP address of the reception part, the reception part confirms whether a destination private IP address exists in the received MLIP packet (step 1105).

When it is determined in the step 1105 that the destination private IP address does not exist in the received MLIP packet, the reception part interchanges the destination public IP address of the MLIP packet with the destination private IP address and records the above IP addresses into the corresponding fields (step 1106).

Then, the reception part confirms whether the destination public IP address is the same as the public IP address of the reception part (step 1107). When it is determined in the step 1107 that the destination public IP address is the same as the public IP address of the reception part, the reception part confirms whether the source private IP address exists in the MLIP packet (step 1108). When it is determined in the step 1108 that the source private IP address exists in the MLIP packet, the reception part interchanges the source public IP address with the source private IP address (step 1109).

Next, the MLIP packet is processed in accordance with the protocol type of the MLIP packet. The reception part confirms whether the MLIP packet is a tunneled IP packet (step 1110). When it is determined in the step 1110 that the MLIP packet is a tunneled IP packet, the reception part removes a header from the IP packet and performs the tunneled IP packet processing procedure (step 1111).

Then, the reception part confirms whether the MLIP packet is an ICMP packet (step 1112). When it is determined in the step 1112 that the MLIP packet is an ICMP packet, the reception part performs an ICMP packet processing procedure (step 1113). Next, the reception part confirms whether the MLIP packet is a TCP packet (step 1114). When it is determined in the step 1114 that the MLIP packet is a TCP packet, the reception part performs a TCP packet processing procedure (step 1115). The reception part confirms whether the MLIP packet is an UDP packet (step 1116). When it is determined in the step 1116 that the MLIP packet is an UDP packet, the reception part performs an UDP packet processing procedure (step 1117).

When the MLIP packet does not correspond to any one among the tunneled IP packet, the ICMP packet, the TCP packet, and the UDP packet, the reception part processes another subroutine (step 1118).

Meanwhile, when it is determined in the step 1107 that the destination public IP address is not the same as the public IP address of the reception part, the reception part confirms whether the source private IP address exists in the MLIP packet (step 1119). When it is determined in the step 1119 that the source private IP address exists in the MLIP packet, the reception part confirms whether the source public IP address is the same as the source private IP address (step 1120). When it is determined in the step 1120 that the source public IP address is the same as the source private IP address, the reception part interchanges the source public IP address with the source private IP address (step 1121).

Then, the reception part calculates IP checksum (step 1122) and confirms whether the destination public IP address is a handover IP address (step 1123). The above step 1123 is also performed when it is determined in the step 1104 that the destination public IP address is not the same as the public IP address of the reception part.

When it is determined in the step 1123 that the source public IP address is a handover IP address, the reception part performs IP packet tunneling (step 1124) and performs IP packet forwarding sequentially (step 1125).

As described above, an internet service using wired and wireless mobile IP addresses may be realized through the transmission and reception processing procedure of the MLIP packet. In the following the compatibility characteristics of the internet service will be described.

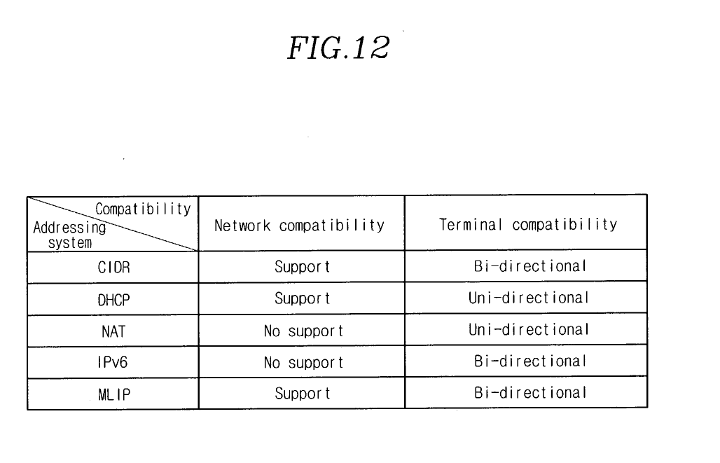

In FIG. 12, a table chart for service compatibility in a case when IP addresses are used in a wired and wireless mobile in accordance with an embodiment of the present invention is illustrated.

With reference to FIG. 12, the service compatibility may be classified as network compatibility and terminal compatibility. Moreover, it may be obvious from the table chart of FIG. 12 that the network compatibility is provided to the CIDR system, the DHCP system, and the MLIP system, each having similar addressing systems.

The NAT (Network Address Translation) system merely uses private internet services and may be accessible only within private networks. The IPv6 system merely supports 16-byte addressing systems, but it does not provide network compatibility.

As described above, the present invention provides a method for transmitting and receiving packets in a wired and wireless combined network so as to realize an internet handover service. Moreover, the method according to the present invention may satisfy requirements to be supported under mobile communication environments such as fixed IP assignment for internet connection, handover, and tunneling etc. by MLIP address.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A method of transmitting and receiving packets for an internet handover service in a wired and wireless combined network, wherein the internet handover service is implemented under a communication environment having a plurality of wireless private networks that use a public network as a backbone, a wireless terminal connected to any one of the wireless private networks, a plurality of wired private networks, and a wired terminal connected to any one of the wired private networks, the method comprising:
(a) the wireless terminal receiving an allocated private IP address from any one of the wireless private networks;
(b) the wired terminal receiving an allocated private IP address from any one of the wired private networks; and
(c) the wireless terminal and the wired terminal each forming an option field of a multi layer IP packet by using the wireless and the wired private IP addresses and a public IP address which is allocated from the public network to each of the wireless and wired private networks, and transmitting and receiving the multi layer IP packet for communication.

2. The method according to claim 1, wherein the multi layer IP packet comprises an option field, and the option field includes:
address information for defining the private IP addresses of a transmission part and a reception part;
length information of the option field;
terminal type information, private IP address, and identification information of the transmission part; and
terminal type information, private IP address, and identification information of the reception part.

3. The method according to claim 1, when the wireless terminal is moved from any one of the wireless private networks to another one of the wireless private networks, further comprising:
the wireless terminal requesting another private IP address from another wireless private network and receiving another allocated private IP address in response to the request;
the wireless terminal requesting mobile IP registration from a foreign agent belonging to the other wireless private network, and performing a tunneling operation between a home agent belonging to one wireless private terminal and a foreign agent belonging to another wireless private network; and
the wireless terminal and the wired terminal each forming a multi layer IP packet by using a wireless private IP address, another wireless private IP address, a wired private IP address, and a public IP address which is allocated from the public network to each of the wireless private networks and the wired private networks, and transmitting and receiving the multi layer IP packet for communication.

4. A method for processing transmission of a multi layer IP packet through an internet service between a wireless terminal belonging to a wireless private network that uses a public network as a backbone and a wired terminal belonging to a wired private network, the method comprising:
(a) a transmission part adding header information into a TCP/UDP payload for data transmission and confirming a public IP address of the public network and a private IP address of the private network, each network belonging to the transmission part, and confirming a public IP address of the public network and a private IP address of the private network, each network belonging to a reception part;
(b) the transmission part recording a source public IP address and a destination public IP address confirmed in (a) into a source address field and a destination address field of an IP packet to be respectively transmitted, and recording the source private IP address and the destination private IP address confirmed in (a) into an option field of the IP packet;
(c) calculating a checksum of a TCP/UDP header by using the source public IP address and the destination public IP address, and recording the checksum into a checksum field; and
(d) comparing the source public IP address with the destination public IP address, interchanging the destination public IP address with the destination private IP address when the two public addresses are the same, calculating and recording the checksum of the total IP packet, and transmitting the IP packet into the reception part.

5. The method according to claim 4, wherein (d) further comprises:
(e) determining whether the source private IP address exists in the IP packet when the two public IP addresses are not the same in (d); and
(f) the transmission part interchanging the source public IP address with the source private IP address when the source private IP address exists in (e), calculating a checksum of the IP packet, and transmitting the IP packet into the reception part.

6. A method for processing reception of a multi layer IP packet through an internet service between a wireless terminal belonging to a wireless private network that uses a public network as a backbone and a wired terminal belonging to a wired private network, the method comprising:
(a) the reception part receiving an IP packet, calculating a checksum of the IP packet, and determining whether a checksum error exists;
(b) the reception part determining whether a public IP address of itself is the same as a reception public IP address when a checksum error does not exist in (a), and confirming whether a destination private IP address exists in the IP packet when the two IP addresses are the same;
(c) the reception part interchanging a destination public IP address with a destination private IP address when it is determined that the destination private IP address exists in the IP packet in (b), confirming whether the interchanged destination public IP address is the same as the public IP address of itself, and determining whether a source private IP address exists in the IP packet when the two public IP addresses are the same; and
(d) interchanging a source public IP address with the source private IP address when it is determined in (c) that the source private IP address exists in the IP packet, and performing packet processing in accordance with properties of the IP packet.

7. The method according to claim 6, further comprising:
renouncing the IP packet when a checksum error exists in (a).

8. The method according to claim 6, wherein (b) further comprises:
determining whether the source public IP address is a handover IP address when the public IP address of the reception part is the same as the destination public IP address, and performing IP packet tunneling and IP packet forwarding when the source public IP address is a handover IP address.

9. The method according to claim 6, wherein (c) further comprises:
the reception part determining whether the source private IP address exists in the IP packet when the interchanged destination private IP address is not the same as the public IP address of the reception part;
the reception part confirming whether the source public IP address of the IP packet is the same as the source private IP address when the source private IP address exists, and interchanging the source public IP address with the source private IP address when the source public IP address of the IP packet is the same as the source private IP address; and
the reception part performing IP packet tunneling and IP packet forwarding when the interchanged source public IP address is a handover IP address.
